(19) United States
(12) Patent Application Publication
(10) Pub. No.: US 2013/0029744 A1
(43) Pub. Date: Jan. 31, 2013

(54) System and Method for the Remote Purchase of Lottery Tickets

(71) Applicants: Bryan Wayne Harding, Springfield, MO (US); James Matthew Miller, Springfield, MO (US)

(72) Inventors: Bryan Wayne Harding, Springfield, MO (US); James Matthew Miller, Springfield, MO (US)

(21) Appl. No.: 13/561,595

(22) Filed: Jul. 30, 2012

Related U.S. Application Data
(60) Provisional application No. 61/513,581, filed on Jul. 30, 2011.

(51) Int. Cl. A63F 13/12

(52) U.S. Cl. 463/17

(57) ABSTRACT

A system and method for enabling remote purchase of lottery tickets. A conveyor of goods uses a communications device to prove, via GPS, that they are in a particular location, such as within a specific state so as to legally purchase a lottery ticket, via the communications device such as a smart phone or other mobile electronic device with equivalent means for confirming the geographic location of the user and device. I participant can log onto an application or website provided by the lottery vendor, prove location to the vendor via the device's connectivity to a GPS system, then purchase a ticket. The method proves current geographical location employing a communications device or an electronic location device when required by another conveyor of a good or service or by requirement of a third party entity including but not limited to a governing or regulatory body.

### CROSS REFERENCE TO RELATED APPLICATIONS

This application claims priority from U.S. Patent Application Ser. No. 61/513,581 entitled “System and Method for the Remote Purchase of Lottery Tickets”, filed on Jul. 30, 2011. The benefit under 35 USC §119(e) of the United States provisional application is hereby claimed, and the aforementioned application is hereby incorporated herein by reference.

### TECHNICAL FIELD OF THE INVENTION

The present invention relates generally to a system and method for providing confirmation that a person is physically and legally located within a predetermined geography of a legal. More specifically, the present invention relates to a system and method for providing confirmation that the person or person(s) executing an action to purchase a lottery ticket are physically and legally located within a predetermined geography of a legal jurisdiction as required to execute a specific action by a governing or regulatory body.

### BACKGROUND OF THE INVENTION

Communications devices and other equivalent electronic mobile devices, such as smart phones, PDAs, and personal computers are used to transmit messages and data having a wide range of informational content. Determining the location of the communications device during a transmission is sometimes determinable by means of a global position system (“GPS”) located within the communications device. Alternatively the communications device may be geographically located by triangulation.

The geographic location of a human being/participant during the transmission or receipt of information, such as in a lottery ticket purchase, is in certain circumstances relevant to the legality of the act of communications. In particular, the purchase of lottery tickets are on occasion limited to transactions where the purchaser/participant is legally required to be located within a predetermined geography of a legal jurisdiction, for example, within state boundary lines by a governing or regulatory body. Still other practical examples of verifying the geographic location of a human being/participant during a transaction would be legally relevant would include the placing of a wager with legitimate casinos.

The methods of determining the location of a communications device having a GPS receiving circuit are well known in the art. In addition, methods of determining the location, or approximate location, of a wireless communications device by means of triangulation, and other suitable prior art methods, are well known in the art.

Statutes and laws in effect in certain jurisdictions by a governing or regulatory body have empowered electronic signatures. Certain statutes have authorized electronic signatures as valid to rely upon for confirming the age and identity of the signer. These electronic signature statues have increased the capability of communications devices and networks as media for implementing and recording legally recognizable actions.

The need has arisen for a method to associate the location of a communications device in order to comply with specific legal requirements for executing an action, such as buying a lottery ticket, in combination with an authentication of the identity of one or more specific persons/participants and confirmation that the person(s)/participant(s) are physically and legally located within a predetermined geography of a legal jurisdiction as required to execute a specific action by a governing or regulatory body.

### SUMMARY OF THE INVENTION

The present invention is a system and method for enabling remote purchase of lottery tickets. The method is one in which the conveyor of a good or service (buyer, seller, or barter participant) proves current geographical location employing a communications device or an electronic location device when required by another conveyor of a good or service or by requirement of a third party entity including but not limited to a governing or regulatory body.

One application of the system and method of the present invention is for a conveyor of goods to use a communications device to prove, via GPS, that they are in a particular location such as within a specific state so as to legally purchase a lottery ticket via the communications device such as a smart phone or other mobile electronic device with equivalent means for confirming the geographic location of the user and device. In other words, the IPAD, smart phone, etc. user/participant could log onto an application or website provided by the lottery vendor, prove location to the vendor via the device's connectivity to a GPS system, then purchase the ticket.

The initial two commerce activities considered by the present invention are lottery and gambling such as para-mutual gambling or any other type of gambling, such as electronic slot games, that could be played in Nevada or other states if one could prove legal location of the participant. An additional potential use of the present invention is for states, provinces, or other governing bodies to determine location for sales tax and/or other regulatory necessities.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a flow chart illustrating the method steps of the present invention;

FIG. 2 is a flow chart illustrating the redemption process of the present invention as directed to a state lottery system; and

FIG. 3 is a flow chart illustrating the redemption process of the present invention as directed to an online and/or video gambling service.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the embodiment of the present invention is a system and method for enabling remote purchase of lottery tickets or participating in para-mutual gambling as illustrated. The method is one in which the conveyor of a good or service (buyer, seller, or barter participant) proves current geographical location employing a communications device or an electronic location device when required by another conveyor of a good or service or by requirement of a third party entity including but not limited to a governing or regulatory body.

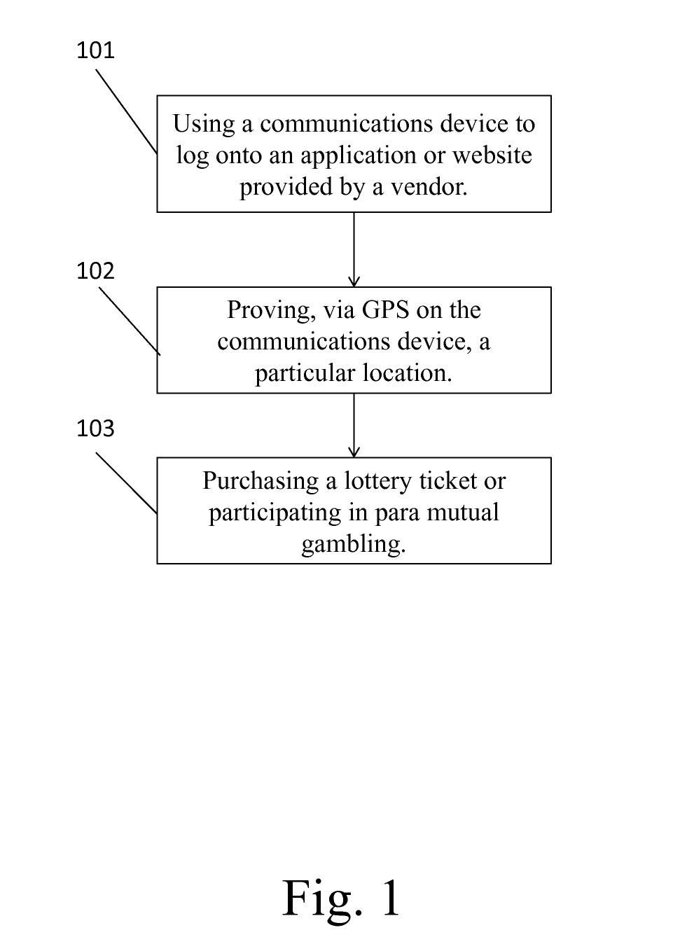

One application of the system and method of the present invention, as shown in FIG. 1, is for a conveyor of goods to use a communications device to prove, via GPS, that they are in a particular location such as within a specific state so as to legally purchase a lottery ticket via the communications device such as a smart phone or other mobile electronic device with equivalent means for confirming the geographic location of the user and device. In other words, an IPAD, smart phone, laptop, etc. user/consumer/participant could log onto an application or website provided by the lottery vendor 101, prove their location to the vendor via the device's connectivity to a GPS system 102, and then purchase a lottery ticket or participate in para mutual gambling 103.

The initial two commerce activities considered by the present invention are lottery and gambling such as para-mutual gambling or any other type of gambling, such as electronic slot games, that could be played in Nevada or other states if one could prove legal location of the participant. An additional potential use of the present invention is for states, provinces, or other governing bodies to determine location for sales tax and/or other regulatory necessities.

The present invention can be employed in any situation where proof of location is required to complete an activity including, but not limited to, the exchange of information, goods or services, and payments via legal tender, credit, etc. An additional requirement may also be to indicate requirements by law, public policy, any industry standard, by individual or business entity best practice.

The method of the present invention will allow for redemption of a credit via a communications device such as a smart phone or other mobile electronic device. Where a “credit” is created or exists in a vendor or consumer account, the credit can be redeemed for valuable consideration via a communications device such as a smart phone or other mobile electronic device using an electronic interface. If proof of location is required by a governing or regulatory body or for any other reason to complete the credit redemption activity including, but not limited to, goods or services, then the GPS component of the process can be employed to confirm physical and legal geographical location of the credit redeemer/participant. If proof of location is not required for the credit redemption activity, then the GPS component to prove a redeemer/participants physical and/or legal geographical location can be bypassed and the credit in exchange for valuable consideration is completed.

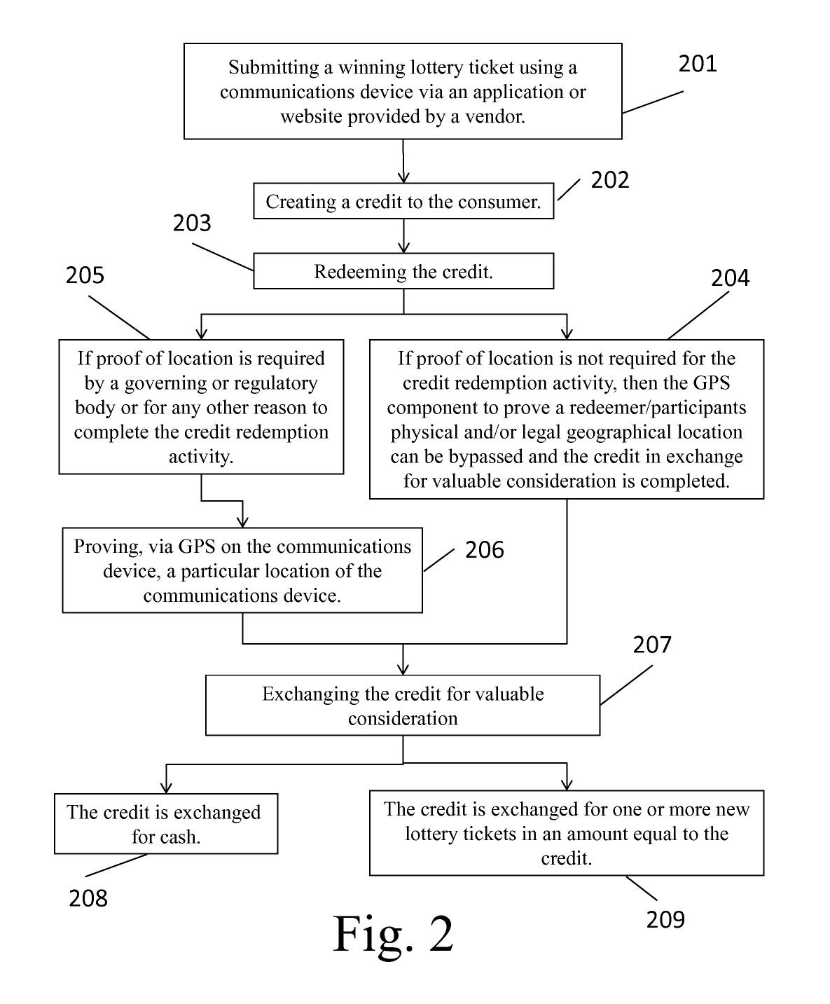

Now referring to FIG. 2, a user/consumer submits a winning lottery ticket using a communications device via an application or website provided by the vendor in step 201. This creates a credit to the user/consumer in step 202. The user/consumer can then redeem the credit in step 203. If proof of location is required by a governing or regulatory body or for any other reason to complete the credit redemption activity then that process occurs in step 205. If proof of location is not required for the credit redemption activity, then the GPS component to prove a redeemer/participants physical and/or legal geographical location can be bypassed and the credit in exchange for valuable consideration is completed in step 204. In step 206, a user/consumer proves their location, via GPS on the communications device, via a particular location of the communications device. The user/consumer can then exchange the credit for valuable consideration in step 207, where the credit is either exchanged for cash in step 208 or the credit is exchanged for one or more new lottery tickets in an amount equal to the credit in step 209.

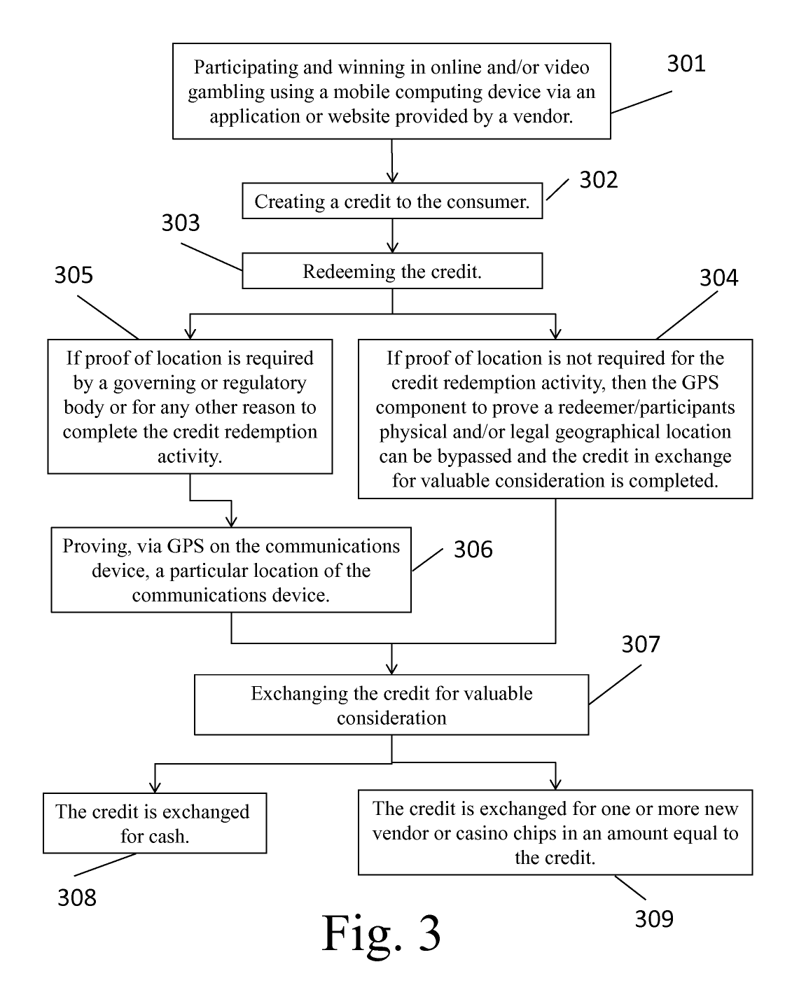

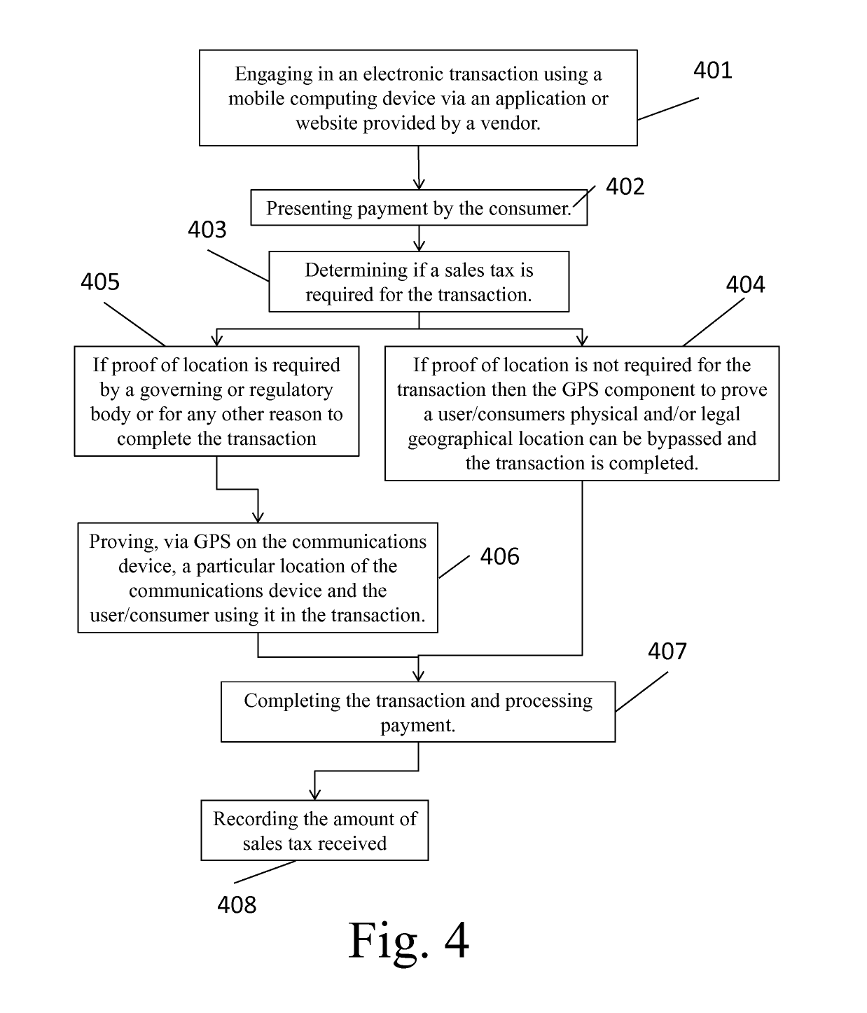

Now referring to FIG. 3, the method of the application as it applies to online and/or video gambling for use in providing, in one example, online and/or video slot machines, by a third party vendor to a user/participant/consumer is taught. A user/consumer participates in and wins a online and/or video gambling game or contest using a communications device via an application or website provided by the vendor in step 301. This creates a credit to the user/consumer in step 302. The user/consumer can then redeem the credit in step 303. If proof of location is required by a governing or regulatory body or for any other reason to complete the credit redemption activity then that process occurs in step 305. If proof of location is not required for the credit redemption activity, then the GPS component to prove a redeemer/participants physical and/or legal geographical location can be bypassed and the credit in exchange for valuable consideration is completed in step 304. In step 306, a user/consumer proves their location, via GPS on the communications device, via a particular location of the communications device. The user/consumer can then exchange the credit for valuable consideration in step 307, where the credit is either exchanged for cash in step 308 or the credit is exchanged for one or more new playable vendor credits or casino chips in the event the third party provider is a casino with a physical location, in an amount equal to the credit in step 309.

In a broad embodiment of the present invention, the method can be used or applied to cover anything required for business practice or regulatory practice of issues where location is required. For example, as show in FIG. 4, the method of the present invention can be applied to an electronic transactions where the payment of sales tax is determined by the location of the purchaser. The method can also be adapted to any other potential transactions where location is determined or required for processing all or part of the transaction.

As shown in FIG. 4, a consumer/user first engages in an electronic transaction using a mobile computing device via a software application or website running on a computer system provided by a vendor 401. The consumer/user presents payment for the goods or services involved in the transaction 402. A determination is then made on ether sales tax is required to be collected for the transaction 403. If sales tax is required based on proof of location of the buyer by a governing or regulatory body or for any other reason to complete the transaction 405 the user/consumer/buyer provides, via GPS on the communications device, a particular location of the communications device and the associated user/consumer/buyer using the device to complete the transaction 406. If no proof of location is required for the transaction, then the GPS component of the communications device proves the user/consumers physical and/or legal geographical location for the transaction record 404. The transaction and processing of payment are completed 407 and the amount, if any, of sales tax charged and received is recorded 408.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for the remote purchase of lottery tickets comprising:
using a communications device to log onto an application or website provided by a vendor;
proving, via GPS on the communications device, a particular location of the communications device; and
purchasing a lottery ticket by a consumer.

2. The method of claim 1, further comprising the step of
proving, via GPS on the communications device, that a user is in a particular location so as to legally purchase a lottery ticket via the communications device.

3. The method of claim 2, further comprising the step of
proving, via GPS on the communications device, that a user is in within a specific state so as to legally purchase a lottery ticket via the communications device.

4. The method of claim 1 wherein the communications device is a smart phone, lap top, tablet computer, or other mobile electronic device with equivalent means for confirming the geographic location of the user and device.

5. The method of claim 1, further comprising the steps of:
submitting a winning lottery ticket using a communications device via an application or website provided by the vendor;
creating a credit to the consumer;
redeeming the credit;
proving, via GPS on the communications device, a particular location of the communications device; and
exchanging the credit for valuable consideration.

6. The method of claim 5 wherein the credit is exchanged for cash.

7. The method of claim 5 wherein the credit is exchanged for one or more new lottery tickets in an amount equal to the credit.

8. A method for the remote play of online gambling machines comprising:
using a communications device to log onto an application or website provided by a vendor;
proving, via GPS on the communications device, a particular location of the communications device; and
participating in online gambling by a consumer using the communications device to access the online gambling game application or website provided by the vendor.

9. The method of claim 8, further comprising the step of
proving, via GPS on the communications device, that a user is in a particular location so as to legally participating in online gambling via the communications device.

10. The method of claim 8, further comprising the step of
proving, via GPS on the communications device, that a user is in within a specific state so as to legally participating in online gambling via the communications device.

11. The method of claim 8 wherein the communications device is a smart phone, lap top, tablet computer, or other mobile electronic device with equivalent means for confirming the geographic location of the user and device.

12. The method of claim 8, further comprising the steps of:
winning a online gambling game using a communications device via an application or website provided by the vendor;
creating a credit to the consumer;
redeeming the credit;
proving, via GPS on the communications device, a particular location of the communications device; and
exchanging the credit for valuable consideration.

13. The method of claim 12 wherein the credit is exchanged for cash.

14. The method of claim 12 wherein the credit is exchanged for one or more new lottery tickets in an amount equal to the credit.

15. A method for determining sales tax during an electronic transaction comprising:
using a communications device to log onto a software application or website provided by a vendor;
proving, via GPS on the communications device, a particular location of the communications device; and
participating in an electronic transaction by a consumer using the communications device to access the software application or website provided by the vendor.

16. The method of claim 15, further comprising the steps of
proving, via GPS on the communications device, that a user is in a particular location so as to legally participating in the electronic transaction via the communications device; and
determining if a sales tax by a governing or regulatory body is required for the goods or services subject to the electronic transaction based on the user's location as provided by the GPS on the communications device.

17. The method of claim 15, further comprising the steps of
proving, via GPS on the communications device, that a user is in within a specific state so as to legally participating in the electronic transaction via the communications device;
determining if a sales tax by a state governing or regulatory body is required for the goods or services subject to the electronic transaction based on the user's location as provided by the GPS on the communications device.

18. The method of claim 15 wherein the communications device is a smart phone, lap top, tablet computer, or other mobile electronic device with equivalent means for confirming the geographic location of the user and device.

19. The method of claim 15, further comprising the steps of:
engaging in an electronic transaction using a communications device via an application or website provided by the vendor;
presenting payment;
determining if a sales tax is required for the transaction;
proving, via GPS on the communications device, a particular location of the communications device for the determination of sales tax; and
completing the payment transaction, including sales tax if required as provided by the determination previously performed.
